(19) United States
(12) Patent Application Publication
(10) Pub. No.: US 2010/0206744 A1
(43) Pub. Date: Aug. 19, 2010

(54) BRINE PURIFICATION

(76) Inventors: Celio Lume Pereira, Stade (DE); Glenn Lord, Lake Jackson, TX (US); Steve Gluck, Like Jackson, TX (US); Bruce Hook, Lake Jackson, TX (US)

Correspondence Address: The Dow Chemical Company, P.O. BOX 1967, Midland, MI, 48641, US

(21) Appl. No.: 12/670,686

(22) PCT Filed: Aug. 18, 2008
(86) PCT No.: PCT/US08/73452

§ 371 Date: Jan. 26, 2010

Related U.S. Application Data
(60) Provisional application No. 60/957,679, filed on Aug. 23, 2007.

(51) Int. Cl. C01D 3/14; C02F 1/461

(52) U.S. Cl. 205/687

(57) ABSTRACT

Process of reducing organic content of brine which includes subjecting a brine solution containing an organic content to an electrochemical process for a sufficient period of time and at a sufficient voltage to reduce the organic content of the brine to obtain a reduced organic content brine. Also provided is a process for reducing organic contamination of brine in a chemical process comprising subjecting a brine stream of the chemical process to electrochemical oxidation to obtain a reduced organic content brine stream.

### CROSS-REFERENCE TO RELATED APPLICATIONS

The present application is related to the following applications, filed on even date herewith, with the disclosures of each the applications being incorporated by reference herein in their entireties:

Application Ser. No. ______ (Attorney Docket No. 66323), filed on even date herewith, entitled “Brine Purification”.

Application Ser. No. ______ (Attorney Docket No. 66324), filed on even date herewith, entitled “Total Organic Carbon (TOC) Reduction in Brine Via Chlorinolysis”.

Application Ser. No. ______ (Attorney Docket No. 66325), filed on even date herewith, entitled “Process and Apparatus for Purification of Industrial Brine”.

Application Ser. No. ______ (Attorney Docket No. 66326), filed on even date herewith, entitled “Process, Adapted Microbes, Composition and Apparatus for Purification of Industrial Brine”.

### BACKGROUND OF THE INVENTION

1. Field of the Invention

The present invention relates to purified brine, particularly brine having reduced organic content, and even more preferably reduced chlorate content. The present invention also relates to processes and apparatus for obtaining brine having reduced organic content, and even more preferably reduced chlorate content, and particularly relates to mineralization of brine. The present invention also relates to improvement of processes and apparatus wherein brine is used in the processes or apparatus so as to include brine therein having reduced organic content, and preferably reduced chlorate content, in brine used therein or brine obtained therefrom. The present invention is useful in various processes and technologies, such as processes involving water, waste water and brine purification, and particularly useful in chlorine/alkali processes, and processes involving conversion of glycerin to epichlorohydrin.

2. Discussion of Background Information

In chemical processes, there is a need to obtain a maximum utility of incoming process streams as well as the ability to recycle process streams, or to use by-products from one process in other processes, particularly in nearby processes. Such uses of process streams are environmentally and economically desirable.

Some chemical processes use a brine stream with high organic content, such as total organic carbon (TOC) and high sodium chloride content. For example, some chemical processes result in a TOC of up to about 20,000 ppm with a sodium chloride content of up to about 23% by weight. If the TOC can be significantly reduced in concentration, there is the possibility for recycling the brine stream as a raw material for other processes, such as a chlor/alkali processes or other electrolysis processes. The presence of sodium chloride may pose difficulties in the removal of organic compounds from various brine by-product streams because some removal processes may cause deleterious precipitation of the sodium chloride in separation equipment. Also, the presence of the chloride ion may result in the formation of undesirably corrosive or toxic chlorinated organic compounds during chemical treatment to destroy the organic compounds.

The brine stream may also contain a variety of organic compounds, some of which may be difficult to remove by traditional techniques such as extraction or carbon bed treatment.

For example, in the production of epichlorohydrin from glycerin, a by-product brine stream may have a TOC of up to about 2500 ppm, typically about 1500 ppm and a sodium chloride content of up to about 23% by weight, typically about 20% by weight. For the successful implementation of a glycerin to epichlorohydrin process and related waste reduction and economic optimization, the discharge of brine should be integrated in the site environmental strategy. The level of sodium chloride is too high for direct discharge, after TOC removal, to the environment. The concentration of NaCl is also too high for effective biological wastewater treatment without significant consumption of fresh water and a corresponding increase in the necessary capacity of the wastewater operation. The main TOC component of the by-product brine stream is glycerin, with the other compounds contributing to TOC of the brine including glycidol, 1,2-dichlorohydrin, or 1,3-dichlorohydrin, 1-chloro-2,3-propanediol, 2-chloro-1,3-propanediol, epichlorohydrin, diglycerol, triglycerol, other oligomeric glycerols, chlorohydrins of oligomeric glycerols, acetic acid, formic acid, lactic acid, glycolic acid, and other aliphatic acids. The TOC specifications for the usage of this brine by a nearby or on-site chlor/alkali process may be only 10 ppm or less. However, the major component of the TOC is glycerin which is difficult to remove by traditional techniques such as extraction or carbon bed treatment.

U.S. Pat. No. 5,486,627 to Quaderer, Jr. et al discloses a method for producing epoxides which is continuous, inhibits formation of chlorinated byproducts, and eliminates or substantially reduces waste water discharge. The method includes: (a) forming a low chlorides aqueous hypochlorous acid solution; (b) contacting the low chlorides aqueous hypochlorous acid solution with at least one unsaturated organic compound to form an aqueous organic product comprising at least olefin chlorohydrin; (c) contacting at least the olefin chlorohydrin with an aqueous alkali metal hydroxide to form an aqueous salt solution product containing at least epoxide; and (d) isolating the epoxide from the aqueous salt solution; wherein water is recovered from the product of at least Step (b) and recycled into Step (a) for use in forming the low chlorides aqueous hypochlorous acid solution. In this process, not only is the water internally recycled after Step (b), but a concentrated brine solution is generated in both Steps (a) and (d) which is useful in other processes such as electrochemical production of chlorine and caustic. The chlorine and caustic, in turn, may then be recycled back for use in forming the low chlorides aqueous HOCl solution. According to U.S. Pat. No. 5,486,627, it is generally preferred, prior to recycling into the chlor-alkali electrochemical cell, to remove any impurities from the brine. These impurities, it is disclosed typically comprise traces of the organic solvent as well as HOCl decomposition products such as chloric acid and chlorate ion. A method for removing these impurities may include acidification and chlorine-based oxidation or absorption on carbon or zeolites.

Methods for removing impurities from brine before passing through a chloralkali electrochemical cell are disclosed in U.S. Pat. No. 5,532,389 to Trent et al, U.S. Pat. No. 4,126,526 to Kwon et al, U.S. Pat. No. 4,240,885 to Suciu et al, and U.S. Pat. No. 4,415,460 to Suciu et al. U.S. Pat. No. 5,532,389 to Trent et al discloses removing chlorates from a chloride brine by contacting the chlorates with acid to convert the chlorates to chlorine. Additionally, it is disclosed that by-product organic compounds, such as propylene glycol present in a brine stream containing alkylene oxide are advantageously removed through any oxidation, extraction or absorption process.

U.S. Pat. No. 4,126,526 to Kwon et al discloses an integrated process for electrolytic production of chlorine and the production of an olefin oxide via the chlorohydrin wherein the chlorohydrin is contacted with an aqueous solution of sodium hydroxide and sodium chloride from the cathode compartment of an electrolytic cell, to produce the oxide and brine. The brine is contacted with gaseous chlorine to oxidize organic impurities to volatile organic fragments, which are stripped from the brine, prior to recycling the brine to the electrolytic cell.

In the processes of the two Suciu et al patents, U.S. Pat. Nos. 4,240,885 and 4,415,460, organic impurities in aqueous salt solutions; e.g., alkali or alkaline earth chloride solutions in particular, brines, are oxidized with chlorate ions to convert organics to carbon dioxide. However the processes employ harsh reaction conditions of high temperatures, which are above 130° C., requiring high pressure equipment, a low pH of less than 5, most preferably less than 1, and chlorate ions which tend to form chlorinated organic compounds.

Conventional processes for purification of brine contaminated with organic impurities include biological treatment; oxidation with chlorine or hypochlorite; absorption over various absorption capable materials such as activated carbon; oxidation with hydrogen peroxide in the presence of dissolved or suspended catalysts or under UV irradiation conditions; oxidation with gaseous oxygen, air or oxygen enriched air in the presence of a dissolved or suspended catalyst; oxidation with ozone in combination with hydrogen peroxide or suspended catalysts. Electrical treatment of aqueous systems, including wastewater, is known, such as disclosed in U.S. Pat. No. 5,399,247 to Carey et al. and Martinez-Huitle et al., “Electrochemical Oxidation of Organic Pollutants for the Waster Treatment: Direct and Indirect Processes”, Chem. Soc. Rev., 2006, 35, 1324-1340, which are incorporated by reference herein in their entireties. However, such electrical treatment is not directed to the treatment of contaminated brine to reduce contaminants therein, or for use of the purified brine as process streams, including feed and recycle process streams.

Opportunities therefore remain to further improve the purification of aqueous brine solutions containing organic compounds so that the brine can be used for chlor-alkali electrolysis.

### SUMMARY OF THE INVENTION

The present invention provides methods for reducing high total organic carbon (TOC) contents of brine streams having a high concentration of sodium chloride, such as a brine by-product stream from the production of epichlorohydrin from glycerin, without deleterious precipitation of the sodium chloride in separation equipment, which can be practiced under a one step process. The formation of undesirably corrosive or toxic chlorinated organic compounds during chemical treatment to destroy the organic compounds is avoided in the present invention. A recyclable brine stream having very low levels of TOC of less than about 10 ppm may be achieved without significant discharge of waste water or consumption of fresh water.

The present invention provides a simple process that can be utilized in one step to achieve efficient brine mineralization to provide brine having reduced organic content. Thus, the present invention provides for the treatment of brine to permit use of brine in which the organic content has been reduced to be used as process feed and/or recycle streams. For example, as discussed above, brine obtained from various processes can contain high concentrations of organic components. For example, in the recovery of brine from conversion of glycerin to epichlorohydrin process for use in chlorine/alkali processes, such as using a chlor/alkali cation exchange membrane, the brine cannot contain a high concentration of organics, such as glycerin. The hydrolyser bottoms stream from the glycerin to epichlorohydrin process (GTE) contains common salt (sodium chloride) in a concentration of over about 16% by weight. The stream is worth recycling to chlorine/alkali process, such as the chlor/alkali membrane process (Membrane C/A). The present invention provides for the efficient use of such process streams by providing a simple and efficient technique for freeing the contaminated brine from the organic contamination, essentially from glycerin which is present in a concentration of usually over about 0.10% by weight (1000 ppm) and from other organic contaminants which may be present in low to trace concentrations.

The present invention provides efficient processes and apparatus for purification of brine, especially brine process streams containing high organic concentration.

The present invention provides processes and apparatus for reducing organic content of brine, preferably in one step, and can surprisingly achieve over about 99% reduction of total organic carbon content of brine in a one step process.

The present invention also provides for further treatment of reduced organic content brine to reduce concentration of chlorate in brine that has been treated to reduce organic content.

The present invention provides a process for purification of brine contaminated with organic compounds by electrochemical oxidation, preferably with subsequent post-treatment of the purified brine to reduce the concentration of chlorate and/or hypochlorite in the brine. Thus, the electrochemical oxidation of the present invention can be followed by further treatment to reduce the concentration of chlorate, such as treatment with sulfite. Preferably, the organic and chlorate content are reduced to an appropriate level such that the purified brine can be fed to chlor/alkali cells (C/A cells), such as chlor/alkali membrane cells.

The present invention provides a process of reducing organic content of brine, comprising subjecting a brine solution containing an organic content to an electrochemical process for a sufficient period of time, at a sufficient current and at a sufficient voltage to reduce the organic content of the brine to obtain a reduced organic content brine.

The present invention also provides a process for reducing organic contamination of brine in a chemical process comprising subjecting a brine stream of the chemical process to electrochemical oxidation to obtain a reduced organic content brine stream.

The brine can have a sodium chloride concentration of seawater to saturation, about 1 wt % to saturation, about 5 wt % to saturation, 8 wt % to saturation, and can have ranges of about 15 to about 22 wt % or about 15 to about 22 wt %.

The pH can be neutral to alkali pH. The pH of the reduced organic content brine can be lowered, such as to a pH of about 1 to about 3, or about 1.5.

The pH of the electrochemical process can be about 7 to about 10. The chlorate and/or hypochlorite content of the reduced organic content brine can be lowered.

The chlorate content can be lowered by addition of an alkali metal sulfite, and the alkali metal sulfite can comprise sodium sulfite or sodium bisulfite or sulfur dioxide.

The electrochemical process can include a titanium anode. The titanium anode can be coated with boron doped diamond.

The brine solution contains an organic content comprises a stream in a chemical process.

The reduced organic content brine can be recycled in the chemical process.

The reduced organic content brine can comprise a feed in a different chemical process.

The process can comprise conversion of glycerin to epichlorohydrin, and the reduced organic content brine can be recycled in the glycerin to epichlorohydrin process.

The recycled brine can be treated to reduce chlorate content.

The chemical process can be a chlor/alkali process, such as a chlor/alkali membrane process.

The reduced content brine can be at least one of recycled in the chemical process, fed to a different chemical process, and stored.

The reduced content brine can be treated to remove at least one of chlorate and hypochlorite.

### BRIEF DESCRIPTION OF THE DRAWINGS

The present invention is further described in the detailed description which follows, in reference to the figures of drawings by way of non-limiting example of exemplary embodiments of the present invention, wherein:

FIG. 1 illustrates a block flow diagram of one embodiment of the present invention wherein electrochemical advanced oxidation and optional chlorate removal are illustrated for a glycerin to epichlorohydrin conversion process wherein the treated brine is recycled to the C/A cell; and

FIG. 2 illustrates an embodiment of a cell for electrochemical advanced oxidation.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The invention can be employed for purification of brine in general, independent of the use of the purified brine.

Brine comprises a salt solution, such as a potassium chloride and/or sodium chloride salt solution, and most commonly comprises a sodium chloride salt solution. The brine can comprise any brine solution, and can comprise brine solutions having a salt concentration as low as the concentration of salt in sea water and as high as saturation of the salt in solution, and can even be present in a concentration over saturation. The brine usually comprises salt concentrations, such as concentration of sodium chloride, of up to about 22 wt %. For example, the brine can be a salt solution comprising sodium chloride at a concentration of about 1 wt % to saturation, about 5 wt % to saturation, about 8 wt % to saturation, with ranges including about 8 to about 12 wt %, or about 15 to about 22 wt %.

This invention provides a process for reduction of organic contamination in brine, usually having a sodium chloride concentration of about 5 wt % or greater by electrochemical oxidation, and preferably subsequent post-treatment. Electrochemical oxidation is performed in a vessel equipped with electrodes which are part of an electrical circuit. The electrodes can be constructed of various materials, and the process can be practiced with addition of substances to improve process efficiency. Conditions of electrical current and tension as well as retention time in the treatment vessel, and temperature and pH of the brine that is to be decontaminated can be adjusted to achieve the decontamination. Yet further, the invention provides a procedure for optional post-treatment of the brine that has been treated in the electrochemical process so as to reduce chlorate content to an appropriately low level, if desired.

Reduction of organic contamination by electrochemical advanced oxidation where the raw (organic contaminated) brine which has been treated by electrochemical oxidation can lead to an increased concentration of chlorate and/or hypochlorite in the treated brine. If desired, the chlorate and/or hypochlorite can be removed from the treated brine, especially in instances where their presence will be constitute an interferent to process conditions and/or be deleterious to the process environment. Thus, a reducing agent such as one or more alkali metal sulfites, such as sodium sulfite, can be added to the treated brine to decrease the chlorate and hypochlorite concentration. The pH of the treated brine can be reduced to a pH of about 1 to about 3, such as about 1.5, to convert hypochlorite to chlorine, and the chlorine can be stripped, such as with steam, or air, or nitrogen. Additionally, a combination of these techniques can be used to obtain combined benefits of using a reducing agent and pH reduction. For example, chlorate removal is needed where the brine will be used in a diaphragm or membrane chlor/alkali processes; wherein the chlorate is an interferent. Moreover, acid treatment will be useful in processes wherein the brine should be acidic.

The present invention differs from other processes in that it can reduce organic contamination in a one-step electrochemical process, optionally combined with a one-step chemical process for mitigation of chlorate and/or hypochlorite.

The present invention differs from the other alternative processes in that it can reduce organic contamination in a one-step process to acceptably low levels such as, for example, the brine purified in this manner can be directly used in various processes, such as feed in chlor/alkali processes. The process provided by the present invention is particularly suitable where electrical energy is economically cost competitive. The present invention enables a high degree of automation and a low level of supervision. Thus, the present invention provides various advantages including simplicity, durability and potential lower cost.

The present invention permits the reduction of total organic carbon (TOC) content of a brine by-product stream to produce a brine stream, such as a recyclable brine stream, having a total organic carbon content of less than about 10 ppm. The brine recycle streams which may be treated in accordance with the present invention may have varying sodium chloride contents as discussed above, and can include sodium chloride from about 15% by weight to about 23% by weight, based upon the weight of the brine by-product stream, a high TOC content of from about 200 ppm to about 20,000 ppm, or from about 500 ppm to about 10,000 ppm, or from about 500 ppm to about 5,000 ppm, and a pH of from about 7 to about 14, or from about 8 to about 13, or from about 10 to about 12.5.

The purified or recyclable brine stream containing a TOC of less than about 10 ppm and a sodium chloride content of about 15% by weight to about 23% by weight, based upon the weight of the recyclable brine stream obtained in the present invention, may be used in a variety of on-site, local, or off-site processes. Exemplary of such processes are chlor/alkali processes, electrochemical processes, such as for the production of chlorine and caustic, production of epoxides, a chlorine alkali membrane process, and the like.

The brine by-product stream treated in accordance with the present invention may be any stream where water, sodium chloride, and TOC is present in a waste, recycle, or by-product stream. Exemplary of brine streams to which the TOC reduction process of the present invention may be applied are brine feed streams, or brine streams produced in processes, such as a recycle or by-product brine stream obtained in the production of epichlorohydrin from glycerin, a liquid epoxy resin (LER) or other epoxy resin brine/salt recycle stream, other chlorohydrin brine recycle streams, an isocyanate brine recycle stream, sea water, reject streams from water purification streams, such as reject streams from reverse osmosis units, waste brine streams from chemical processes, feed brine streams for chlor/alkali processes, and especially feed streams in chlor/alkali processes which are sensitive to organics. The low levels of TOC may be obtained even with brine recycle streams containing substantial amounts of difficult to remove organic compounds such as glycerin.

For example, the processes of the present invention are eminently applicable to the treatment of a brine by-product stream produced in the production of epichlorohydrin from glycerin. A brine by-product stream from a glycerin to epichlorohydrin (GTE) process which may be treated in accordance with the present invention may have an average total organic carbon (TOC) content of at least about 200 ppm, generally at least about 500 ppm, for example from about 1000 ppm to about 2500 ppm, and can be about 1500 ppm. The GTE brine by-product stream subjected to the TOC reduction of the present invention may have a glycerin content of at least about 50% by weight, generally at least about 70% by weight by weight, based upon the weight of the total organic carbon content, and a sodium chloride content of from about 15% by weight to about 23% by weight, based upon the weight of the brine by-product stream. The other organic compounds contributing to TOC in the GTE by-product stream include glycidol, acetol, bis-ethers, dichloro propyl glycidyl ethers, 1,3-dichloro-2-propanol, 2,3-dichloro-l-propanol, 1-chloro-2,3-propanediol, or 2-chloro-1,3-propanediol, epichlorohydrin, diglycerol, triglycerol, other oligomeric glycerols, chlorohydrins of oligomeric glycerols, acetic acid, formic acid, lactic acid, glycolic acid, and other aliphatic acids.

Amounts of certain organic compounds are presented below in Table 1 based on the total weight of the respective organic compound in the aqueous brine solution.

TABLE 1
Preferred Concentrations of Organic Compounds
in Parts-per-Million (ppm)

| Organic Compound | Preferred Minima | | | Preferred Maxima | | |
|---|---|---|---|---|---|---|
| Glycerine | 0 | 500 | 2,000 | 5,000 | 10,000 | 50,000 |
| Glycidol | 0 | 50 | 200 | 500 | 1,000 | 5,000 |
| Hydroxy-2- | 0 | 10 | 40 | 100 | 300 | 1,000 |
| propanone | | | | | | |
| Bis-Ethers | 0 | 0.01 | 0.1 | 1 | 5 | 10 |
| Dichloropropyl | 0 | 0.01 | 0.1 | 11 | 22 | 33 |
| glycidyl ethers | | | | | | |
| Epichlorohydrin | 0 | 0.01 | 0.1 | 1 | 10 | 100 |
| Bisphenol A | 0 | 100 | 500 | 5,000 | 10,000 | 50,000 |
| Bisphenol F | 0 | 100 | 500 | 5,000 | 10,000 | 50,000 |
| Diglycidyl ether of | 0 | 100 | 500 | 5,000 | 10,000 | 50,000 |
| bisphenol A | | | | | | |
| Aniline | 0 | 100 | 500 | 5,000 | 10,000 | 50,000 |
| Methylene | 0 | 100 | 500 | 5,000 | 10,000 | 50,000 |
| dianiline | | | | | | |
| Phenol | 0 | 100 | 500 | 5,000 | 10,000 | 50,000 |
| Formate | 0 | 1 | 5 | 75 | 400 | 1000 |
| Acetate | 0 | 1 | 5 | 75 | 400 | 1000 |
| Lactate | 0 | 1 | 5 | 75 | 400 | 1000 |
| Glycolate | 0 | 1 | 5 | 75 | 400 | 1000 |

The electrodes utilized in the electrochemical oxidation can be constructed of various materials to permit the reduction of organic content of the brine. Preferably, titanium anode coated with boron doped diamond is used to achieve anodic oxidation. Using a Ti-Diamond-B anode, excellent results are possible with the present invention especially due to a high over-potential for generation of O₂ and Cl₂ (water and sodium chloride electrolysis). Such electrodes are commercially available from Adamant—CH, Magneto—NL, Condias—D [DIACHEM®]. In this manner, the organic carbon content of the brine can be lowered while not generating significant amounts of O₂ and Cl₂, and is selective for lowering the organic content.

Without wishing to be bound by theory, OH radicals are generated in the electrochemical oxidation having an exceptionally high oxidation potential ˜2.7 V, usable for oxidation of organic compounds.

The mineralization of organics according to the present invention is especially useful in glycerin to epichlorohydrin conversion wherein organics, such as glycerin, can be mineralized (and thereby reduced) such as to form carbon dioxide. The present invention is particularly useful in treating brine useful in chemical processes as there is a highly efficient oxidation of the organics to carbon dioxide without detrimental side-reactions. A low TOC content may be achieved while not obtaining detrimental side-reactions even when reducing difficult to remove organics, such as glycerin.

Without wishing to be bound by theory, the chemoelectrical oxidation according to the present invention is a procedure involving oxidation by removing electrons from one substance to form another substance which has a lower free energy. The electrical oxidation is simpler than chemical oxidation which involves production and purification of a reagent and then use of the reagent. In the present invention, the reagent is generated “in situ” or the oxidation is directly on the electrode surface.

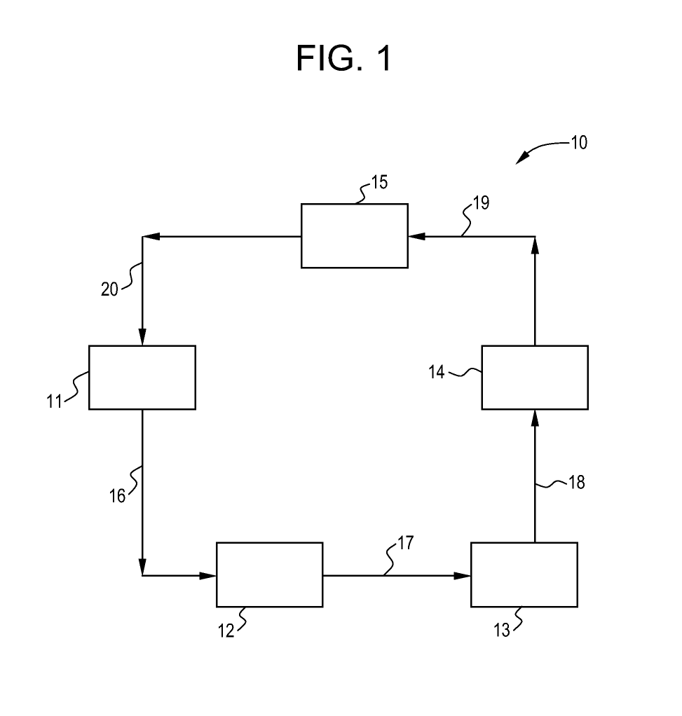

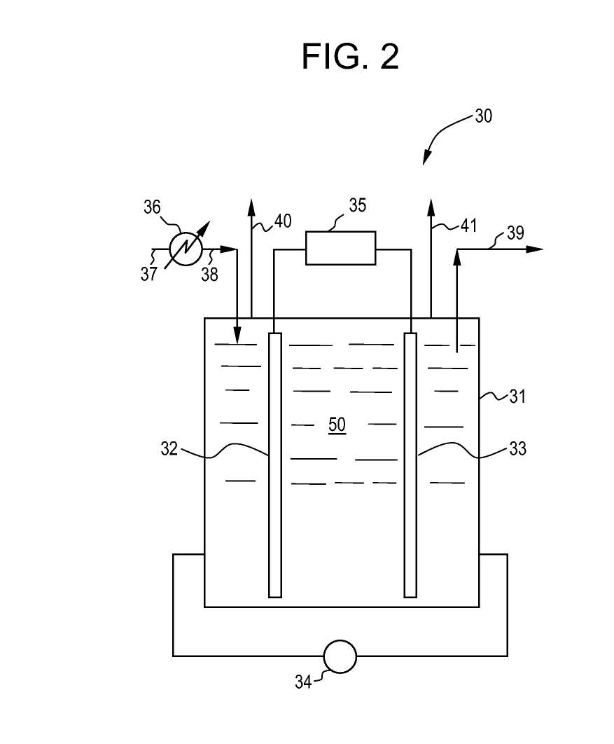

As illustrated in FIG. 1, there is shown one embodiment of the process of the present invention, generally indicated by numeral 10. The process 10 is especially useful for providing process water recycle in a glycerin to epichlorohydrin (GTE) process 11. As illustrated, in FIG. 1, the contaminated process water 16 from the GTE process at 11 can be sent through an optional heat exchanger 12 to raise or lower the temperature of the contaminated process water 16. The contaminated process water 17 from the heat exchanger 12 is forwarded to an electrochemical advanced oxidation cell 13 (an embodiment thereof of which is illustrated in FIG. 2) wherein the organic content of the contaminated process water 17 is reduced. From the electrochemical advanced oxidation cell 13, the reduced organic content water 18 is forwarded to apparatus 14 for optional adjustment of pH for carbon dioxide removal and/or treatment to remove chlorate, such as by addition of sodium sulfite. The reduced organic content/reduced chlorate water 19 is then forwarded to the C/A cell 15 as recycle process water to be used in the process. A brine stream 20 from the C/A cell 15 can be used as the feed stream to the GTE process 11.

FIG. 2 illustrates an exemplary electrochemical advanced oxidation cell, generally indicated by numeral 30, according to the present invention. The electrochemical reactor 30 comprises a housing 31 containing a brine solution 50 to be treated. The electrochemical cell 30 also is equipped with an anode 32 and a cathode 33, such as but not limited to titanium coated with boron-doted diamond. A circulation pump 34 provides agitation of the brine contents 50 of the electrochemical reactor 30. Adjustment of current through the electrical circuit is achieved with the power supply 35. Adjustment of temperature in the electrochemical reactor can be obtained using a heat exchanger 36, which can be located anywhere respect to the electrochemical reactor 30. In FIG. 2, the heat exchanger 36 may be for example, in the feed stream to the electrochemical cell 30 between lines 37 and 38. The heated stream 38 may comprise for example water, NaCl and organics from a GTE process. A treated brine product stream 39 may comprise for example water and NaCl which may be sent to a C/A process. A carbon dioxide gas stream and a hydrogen gas stream may exit the electrochemical reactor via streams 40 and 41 respectively.

The temperature of the electrochemical reactor 30, may be, for example, at around room temperature or elevated temperature, such as about 20° C. or greater, about 30° C. or greater, about 40° C. or greater, and can include temperatures in the range of about 20° C. to 70° C. Adjustment of pH of the contents of the electrochemical reactor can be achieved by adjustment of the pH of the feed or of the reactor bulk contents. For example, the pH can be neutral to alkaline, with a non-limiting range being from about 7 to about 10. Also, the hydraulic residence time of the contents of the reactor 30 can be adjusted.

Residence time, electrical potential and temperature can be adjusted to obtain desired reduction of organic content. The electrochemical oxidation can be operated in constant voltage or constant current mode.

Optionally, as discussed above, sodium sulfite can be added to the brine in sufficient quantity to reduce chlorate and/or hypochlorite to a desired level, such as at a concentration of from about 500 to about 50,000 mg per liter. The optional post-treatment of the electrochemically treated brine achieves mitigation of chlorate which is often co-produced in the electrochemical oxidation.

Also, as discussed above, there can also be an optional post-treatment of the electrochemically treated brine for mitigation of hypochlorite by acidification, and stripping, such as with steam, or air, or nitrogen.

The optional post-treatment can be is performed at various temperatures included elevated temperatures, and is preferably performed above about 40° C.

Optionally, complimentary to reduction of chlorate is removal of sulfate by addition of alkaline earth metal carbonate, such as calcium carbonate followed by removal of the precipitated alkaline earth metal sulfate.

All references cited herein are specifically incorporated by reference herein.

The examples presented below demonstrate significant advantages of the present invention including the surprising reduction of organic content of brine. All parts are by weight unless specifically noted.

### Example 1

The equipment consisted of a jacketed glass reactor of 0.32 liter effective volume, equipped with a holder to which an anode and cathode were attached; a magnetic agitator; a short pipe inlet piece connected to a peristaltic pump for feed supply from a storage vessel; a short pipe outlet piece for overflow of the reactor effluent into a collecting vessel; a thermostat connected to the inlet and outlet pipe pieces of the reactor jacket. The electrodes were connected to the appropriate poles of a rectifier operated with 220 V power supply. The reactor jacket was further connected to a cryostat which was adjusted to maintain the temperature of the reactor contents at constant 40° C.

The reactor was filled with raw brine with a sodium chloride content of 18% and an organic content corresponding to 1700 mg/l dissolved organic carbon (DOC), adjusted to a pH of 10. The feed storage vessel contained the same material. After starting the agitator and the cryostat, the feed pump was started at a rate of 1.8 ml/min corresponding to a hydraulic mean residence time of approximately 180 minutes in the reactor. The rectifier was then adjusted to deliver a DC current of 20 A. Current and tension were monitored at regular intervals, the latter on a voltmeter connected directly to the electrode clamps. Temperature of the reactor contents was also monitored; the pH of the effluent was measured at regular intervals using pH color stripes (Merck™). The energy uptake was 0.238 kWh on an average during the 10 hour duration of the experiment. The organic contamination of the effluent as DOC was found to be 6.3 mg/l+/−1 mg/l. The concentration of sodium hypochlorite, which was below detection limits in the untreated brine, had increased to 6005 mg/l, and the chlorate concentration, which was negligible in the raw brine, was found to have increased to 34 g/l on an average. 100 ml of the collected effluent were acidified to pH 1.5 by addition of 32% aqueous hydrochloric acid and then placed in a round-bottom glass flask equipped with an electrical heating jacket, a magnetic agitator, a reflux condenser connected to cold water supply, and a dropping funnel. A solution of 15.4 g sodium sulfite in 30 ml distilled water was placed in the dropping funnel. The contents of the round-bottom flask were heated to 100° C. and thereafter the contents of the dropping funnel were added to the flask all at once. The reaction mixture was agitated for 30 minutes at the same temperature, the heating stopped and the flask contents allowed to cool to ambient temperature and analyzed for chlorate by ionic chromatography with electrochemical detection. The chlorate concentration had decreased to 100 mg/l.

### Example 2

0.32 l of brine containing 19.8% sodium chloride and 1900 mg/l DOC content was placed in the reactor and about 1000 ml of the same material in the feed storage vessel. The reaction was carried out under otherwise same conditions as above but at a current adjusted to constant 10 A. The energy uptake was 0.145 kWh, the feed rate was 1.3 ml/min corresponding to a mean hydraulic residence time of 4 hours in the reactor. The effluent was collected as before and analyzed. The DOC content was 35 mg/l, the chlorate content was 5850 mg/l and the sodium hypochlorite content was 7550 mg/l. 100 ml of this material were placed in a round-bottom flask as in the previous experiment and acidified to pH 1.5 by addition of 32% hydrochloric acid. The contents were heated to 100° C. and agitated at this temperature for 60 minutes. A sample was then withdrawn and analyzed for sodium hypochlorite by iodine titration with potentiometric endpoint recognition. The sodium hypochlorite content had decreased to a level below the detection limit of the method, which is 5 mg/l. Thereafter the pH was readjusted to 1.0 by addition of 32% aqueous hydrochloric acid, transferred to the round-bottom flask, heated under agitation to 100° C. and a solution of 2.65 g sodium sulfite dissolved in 5 ml distilled water added all at once. The flask contents were agitated at this temperature for 30 minutes, thereafter allowed to cool to ambient temperature and finally analyzed for chlorate by ionic chromatography. The chlorate content had decreased to 100 mg/l.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods, processes, and uses, such as are within the scope of the appended claims.

What is claimed is:

1. A process of reducing organic content of brine, comprising subjecting a brine solution containing an organic content to an electrochemical process for a sufficient period of time and at a sufficient voltage to reduce the organic content of the brine to obtain a reduced organic content brine.

2. The process according to claim 1 wherein the brine has a sodium chloride concentration of seawater to saturation.

3. The process according to any one of the preceding claims wherein the brine has a sodium chloride concentration of about 1 wt % to saturation.

4. The process according to any one of the preceding claims wherein the brine has a sodium chloride concentration of about 5 wt % to saturation.

5. The process according to any one of the preceding claims wherein the brine has a sodium chloride concentration of about 8 wt % to saturation.

6. The process according to any one of the preceding claims wherein the brine has a sodium chloride concentration of about 15 to 22 wt %.

7. The process according to any one of the preceding claims wherein the brine has a sodium chloride concentration of about 15 to 22 wt %.

8. The process according to any one of the preceding claims, wherein the pH is a neutral to alkali pH.

9. The process according to any one of the preceding claims, further comprising reducing the pH of the reduced organic content brine.

10. The process according to any one of the preceding claims wherein the pH of the reduced organic content brine is reduced to a pH of about 1 to 3.

11. The process according to any one of the preceding claims wherein the pH of the reduced organic content brine is reduced to a pH of about 1.5.

12. The process according to any one of the preceding claims wherein the pH of the electrochemical process is about 7 to 10.

13. The process according to any of the preceding claims further comprising reducing chlorate content of the reduced organic content brine.

14. The process according to any of the preceding claims further comprising reducing hypochlorite content of the reduced organic content brine.

15. The process according to claim any of the preceding claims wherein the chlorate content is reduced by addition of an alkali metal sulfite or alkali metal bisulfite, or sulfur dioxide.

16. The process according to claim 15, wherein the alkali metal sulfite comprises sodium sulfite.

17. The process according to claim 15, wherein the alkali metal bisulfite comprises sodium bisulfite.

18. The process according to any one of the preceding claims, wherein the electrochemical process includes a titanium anode.

19. The process according to claim 18 wherein the titanium anode is coated with boron doped diamond.

20. The process according to any one of the preceding claims, wherein the brine solution containing an organic content comprises a stream in a chemical process.

21. The process according to claim 20, wherein the reduced organic content brine is recycled in the chemical process.

22. The process according to claim 20 or claim 21, wherein the reduced organic content brine comprises a feed in a different chemical process.

23. The process according to any one of claims 20 to 22 wherein the process comprises conversion of glycerin to epichlorohydrin.

24. The process according to any one of claim 20 to claim 23, wherein the reduced organic content brine is recycled in the glycerin to epichlorohydrin process.

25. The process according to claim 24 wherein the recycled brine is treated to reduce chlorate content.

26. The process according to claim 20 wherein the chemical process is a chlor/alkali process.

27. The process according to claim 26 wherein the chemical process is a chlor/alkali membrane process.

28. A process for reducing organic contamination of brine in a chemical process comprising subjecting a brine stream of the chemical process to electrochemical oxidation to obtain a reduced organic content brine stream.

29. The process according to claim 28, wherein the reduced content brine is at least one of recycled in the chemical process, fed to a different chemical process, and stored.

30. The process according to claim 28 or claim 29 wherein the reduced content brine is treated to remove at least one of chlorate and hypochlorite.

31. A process for reducing organic contamination of brine in a chemical process comprising subjecting a brine stream of the chemical process to the purification process of claim 1; wherein the organic content of purified brine is sufficiently low to be recycled back to the same chemical process or a different chemical process.

32. The process according to claim 31, wherein the chemical process is a process for making epichlorohydrin and the different chemical process is a chlor-alkali process.

33. The process according to claim 31, wherein the chemical process is a process for reacting a polyphenol compound with epichlorohydrin to make epoxy resins and the different chemical process is a chlor-alkali process.

34. The process according to claim 33, wherein the chemical process is a process for making liquid epoxy resin or solid epoxy resin from bisphenol-A and epichlorohydrin.

35. The process according to claim 33, wherein the chemical process is a process for making liquid epoxy novolac resin from bisphenol-F, or bisphenol-F oligomers, and epichlorohydrin.

36. The process according to claim 31, wherein the chemical process is a process for making methylene dianiline, or poly-methylene dianiline oligomers from phenol and formaldehyde in the presence of a hydrochloric acid.

37. The process according to claim 31, wherein the chemical process is a process for making epichlorohydrin from glycerin.

38. The process according to any one of claims 31 to 37, wherein the weight-ratio of the amount of organic compound to the amount of sodium chloride present in the second purified brine solution obtained in the second redis solution step is less than about one-hundredth of the weight-ratio of the amount of organic compound to the amount of sodium chloride present in the aqueous brine solution provided in step (1).

39. The process according to any one of the preceding claims, wherein the one or more organic compounds comprise(s) (a) one or more multihydroxylated-aliphatic hydrocarbon compound(s), ester(s) thereof and/or monoepoxides thereof, and/or dimers, trimers and/or oligomers thereof, and/or halogenated and/or aminated derivatives thereof, (b) one or more organic acids having from 1 to 10 carbon atoms, ester(s) thereof, monoepoxide(s) thereof and/or salt(s) thereof, (c) one or more alkylene bisphenol compound(s) and/or epoxide(s), diols and/or chlorohydrins thereof, and/or (d) aniline, methylene dianiline, and/or phenol.

40. The process according to claim 39, wherein the one or more multihydroxylated-aliphatic hydrocarbon compound(s) comprise(s) glycerol.

41. The process according to claim 39, wherein the one or more organic acids comprise(s) formic acid, acetic acid, lactic acid and/or glycolic acid.

42. The process according to claim 39, wherein the one or more alkylene bisphenol compound(s) comprise(s) bisphenol A and/or bisphenol F.

43. The process according to any one of claims 39 to 42, wherein the aqueous brine solution provided in step (1) is produced by epoxidation of chlorohydrin(s) by reacting chlorohydrins with sodium hydroxide.

44. The process according to claim 43, wherein the chlorohydrin(s) is/are produced by contacting a liquid-phase reaction mixture comprising glycerol and/or ester(s) thereof and/or monochlorohydrin(s) and/or ester(s) thereof with at least one chlorinating feed stream comprising at least one chlorinating agent, optionally in the presence of water, one or more catalyst(s), and/or one or more heavy byproduct(s) in a reaction vessel under hydrochlorination conditions.

45. The process according to any one of claim 39, 42 or 43, wherein the aqueous brine solution provided in step (1) is produced by epoxidation of at least one alkylene bisphenol compound.

46. The process according to claim 39, wherein the aqueous brine solution provided in step (1) comprises aniline, methylene dianiline and/or phenol and is produced by sodium hydroxide neutralization of hydrogen chloride used to catalyze the reaction of aniline with formaldehyde to make methylene dianiline (MDA).

47. The process according to claim 46, wherein the aqueous brine solution produced by sodium hydroxide neutralization of hydrogen chloride is subjected to azeotropic distillation to remove at least 50 weight-percent of aniline and/or methylene dianiline present in the aqueous brine solution prior to providing the aqueous brine solution in step (1).

48. The process according to claim 47, wherein the aqueous brine solution provided in step (1) has not been subjected to a stripping operation to remove aniline and/or methylene dianiline prior to the first redissolution operation.

49. The process according to any one of the preceding claims, wherein the total organic carbon concentration (TOC) of the aqueous brine solution provided in step (1) is at least about 200 ppm.

50. The process according to any one of the preceding claims, wherein less than about 5 weight-percent of the inorganic salt of the aqueous brine solution provided in step (1) is salt having carbonate and/or sulfate anions.

51. The process according to any one of the preceding claims, wherein the purified brine solution obtained in step (2) has a total organic carbon concentration less than about 10 ppm.

52. The process according to any one of the preceding claims, wherein the purified brine is introduced into the anode side of an electrolytic cell as at least a portion of brine starting material for making (a) sodium hydroxide and (b) chlorine gas or hypochlorite via the chlor-alkali process.

53. The process according to any one of the preceding claims, wherein the process is a continuous process.
